(19) United States
(12) Patent Application Publication
(10) Pub. No.: US 2010/0243793 A1
(43) Pub. Date: Sep. 30, 2010

(54) FLYING APPARATUS

(75) Inventor: PHILLIP MATTHEW JERMYN, HAVANT (GB)

Correspondence Address: MCKEE, VOORHEES & SEASE, P.L.C., 801 GRAND AVENUE, SUITE 3200, DES MOINES, IA, 50309-2721, US

(73) Assignee: ALIEN TECHNOLOGIES LTD, Kowloon (HK)

(21) Appl. No.: 12/475,033

(22) Filed: May 29, 2009

(30) Foreign Application Priority Data
Mar. 24, 2009 (GB) 0905029.5

(51) Int. Cl. B64C 27/08; B64C 11/20

(52) U.S. Cl. 244/17.23; 416/139

(57) ABSTRACT

Flying apparatus includes a housing and rotary means associated with said housing capable of rotation in use. The rotary means includes two or more rotary blades. Each rotary blade has weighted means associated with at least a part of a leading edge thereof.

### CROSS REFERENCE TO RELATED APPLICATIONS

This application claims priority from United Kingdom Application 0905029.5 filed Mar. 24, 2009, which is hereby incorporated by reference in its entirety.

### BACKGROUND OF THE INVENTION

This invention relates to flying apparatus, and particularly although not necessarily exclusively, to flying toy apparatus capable of undergoing a hovering motion.

It is known to provide flying toy apparatus which is capable of undergoing hovering airborne motion in use, thereby providing interest to both child and toy users. An example of such hovering apparatus is a helicopter.

A helicopter typically includes an aircraft body with a plurality of rotary blades located above said body. The rotary blades allow the helicopter to hover using the lift force generated by rotation of the rotary blades which acts against the opposite gravitational force applied to the helicopter body. A helicopter should be able to hover in a single airborne position providing the helicopter is level and no additional external forces are being applied to the same. However, if the helicopter is tilted in any direction, such as a result of air disturbance, then the lift force will have a horizontal force component and this will cause the helicopter to accelerate horizontally in the direction of the tilt. In a typical helicopter, the pilot provides control input to keep the machine level. The pilot is helped by the gyroscopic stability provided by the rotor. This has the effect of heavily damping tilt movements to allow the helicopter to respond sufficiently slowly for the pilot to control it.

If a helicopter is allowed to hover without pilot intervention, such as with a toy helicopter, it will typically develop a tilt in a particular direction, for example as a result of air movement or disturbance, and then start to accelerate in that direction. Due to the drag force of the helicopter body located beneath the rotary blades, the helicopter will then be subject to a moment force tending to increase the tilt angle further. Since the rotor of a helicopter is a form of gyroscope and is subject to gyroscopic precession, when an external force is applied to the helicopter inertial forces create a reaction that is orientated at approximately 90 degrees in the plane of rotation to the external force. This typically results in the helicopter moving through a circular path of increasing diameter and increasing speed until the helicopter eventually crashes.

In order to prevent or limit the above problem, it is known to provide stabilisation mechanisms with the helicopter. An example of an inherent stabilisation mechanism for a toy helicopter is disclosed in U.S. Pat. No. 7,494,397.

### SUMMARY OF THE INVENTION

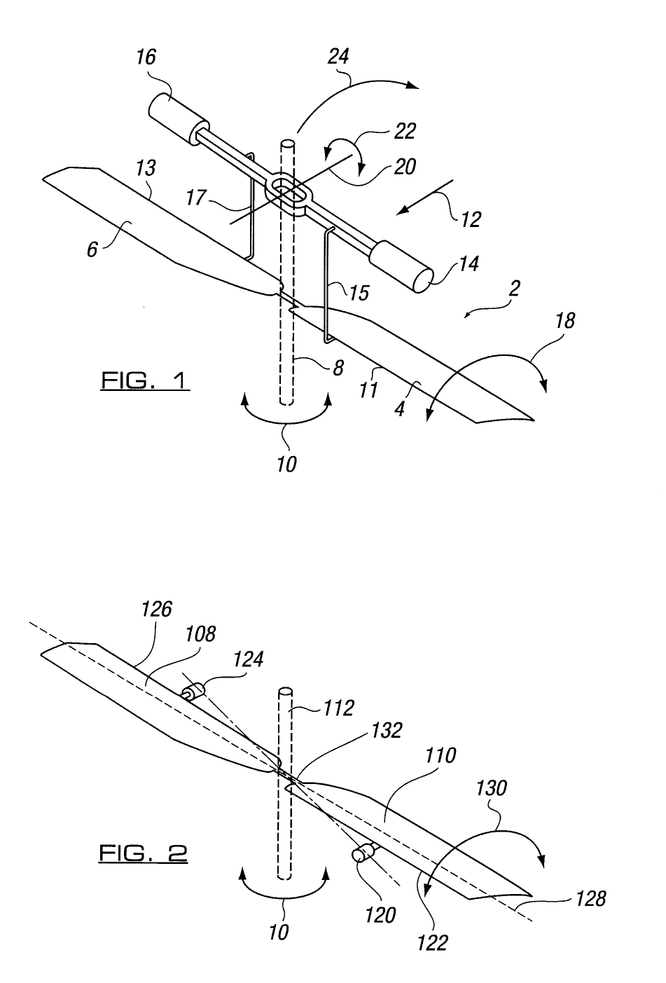

FIG. 1 shows a detailed view of a prior art stabilisation mechanism similar to the type used in U.S. Pat. No. 7,494,397. The mechanism includes a primary two blade rotor 2 having a first blade 4 and a second blade 6 rotatable about a central rotary shaft 8 in the direction shown by arrow 10. A secondary rotor or “flybar” 12 is mounted above rotor 2 and includes a first weight 14 and a second weight 16. The first weight 14 is connected to leading edge 11 of first blade 4 via a linkage arm 15 and the second weight 16 is connected to leading edge 13 of the second blade 6 via a linkage arm 17.

Primary rotor 2 is able to pivot or “teeter” about an axis substantially parallel to the longitudinal axis of blades 4, 6, as shown by arrow 18, thereby allowing twisting of the blades. This twisting action is controlled by flybar 12 which is able to pivot orthogonally or perpendicularly to the primary rotor pivot axis 20, as shown by arrow 22. The arrangement allows blades 4 and 6 to be twisted as the weights 14 and 16 of the flybar move up and down.

If a disturbance tilts the structure, which in the illustrated example is provided in a forwardly direction shown by arrow 24, inertial forces in the flybar 12 will drive weight 14 in a downwardly direction and weight 16 in an upwardly direction. This reduces the pitch and therefore the lift generated by first blade 4 and increases the pitch and lift generated by second blade 6. This lift imbalance between blades 4, 6 tries to tilt blades 4, 6 to the right (i.e. 90 degrees to the forwardly disturbance 24); the resulting gyroscopic reaction from the spinning structure tilts the blades in a backwardly direction opposing the forwardly direction of the original disturbance 24.

There will obviously be a direct gyroscopic reaction force generated to the original disturbance 24, as a result of gyroscopic precession, which will act at 90 degrees to the disturbance 24. However, this is much smaller than the aerodynamically induced backward force produced as a result of negative feedback. Since the final result is the vector sum of the two individual forces, the net feedback is substantially in a backwardly direction. Even so, in order to fully compensate for the residual gyroscopic reaction, the secondary rotor is mounted at a slight angle ahead in relation to the primary rotor rather than being parallel to it. This phase-lead balances the angular lag caused by the 90 degree reaction force.

A problem with the above stability mechanism is that it is relatively complex, has a large number of parts and therefore is relatively expensive to manufacture.

It is therefore an aim of the present invention to provide flying apparatus with a stability mechanism which overcomes the abovementioned problems.

It is a further aim of the present invention to provide a rotor arrangement which overcomes the abovementioned problems.

It is a yet further aim of the present invention to provide a method of using flying apparatus and/or a rotor arrangement which overcomes the abovementioned problems.

According to a first aspect of the present invention there is provided flying apparatus, said apparatus including a housing and rotary means associated with said housing capable of rotation in use, said rotary means including two or more rotary blades and wherein each of said rotary blades has weighted means associated with at least a part of a leading edge of said rotary blades.

The weighted means act in the same manner as the “flybar” described above in the prior art to allow tilting of the rotary blades (i.e. at least partial rotation or twisting of the rotary blades about an axis substantially parallel to the longitudinal axis of the blades), thereby providing an inherent stabilisation mechanism. However, since the weight means are directly associated with, fixed or provided on the leading edge of the main rotary means of the apparatus and there is no requirement for a secondary upper rotary arrangement or flybar above the main or primary rotary arrangement as in the prior art, the resulting design of the present invention is both simpler and more lightweight compared to the prior art design. This results in the apparatus having better flying capabilities and is both easier and less expensive to produce.

The flying apparatus of the present invention is inherently stable and will maintain a hovering motion without the need for direct pilot control or any pilot control input, other than throttle or lift generated by drive means of the apparatus.

Preferably the apparatus includes drive means to drive rotation of the rotary means in use. The drive means are preferably location in the housing.

The weighted means can take any suitable form providing they protrude outwardly in front of or ahead of the leading edge of the rotary blade and are of sufficient weight to allow tilting of the rotary blades in use. Thus, in an embodiment where the apparatus has two rotary blades, the weighted means protrude in substantially opposite directions to each other from the leading edges of said blades (i.e. both weighted means protrude in the direction of rotation of the rotary means).

The weighted means can be integrally formed with the rotary blades or can be attached or detachably attached to said rotary blades via attachment means. The attachment means can include any or any combination of one or more screws, adhesive, clips, ties, hook and loop fastening, welding, inter-engaging means, friction fit and/or the like but have to be sufficiently strong and secure to withstand the centrifugal forces applied thereto during rotation of the rotary means in use.

The weighted means on each of the rotary blades can be the same weight or different weight and/or the position of the weight means along the leading edge of the rotary blade can be the same or different on the rotary blades providing the final rotary blade arrangement is substantially balanced. The weight means can protrude any suitable distance from a leading edge of each rotary blade as required providing the final rotary arrangement is substantially balanced.

The weighted means on each blade is substantially of the same weight. Each weighted means is preferably spaced substantially the same pre-determined distance from the main axis of rotation of the rotary blades in use and/or each weighted means preferably protrudes from the leading edge of the rotary blades by substantially the same distance.

The weighted means can include a single weighted portion on a particular rotary blade (i.e. at a single location) or can include two or more weighted portions on a rotary blade (i.e. at two or more locations). If two or more weighted portions are provided on a rotary blade, the two weighted portions can be adjacent each other or a spaced distance apart from each other on said blade.

Preferably the rotary means are rotatable about a substantially primary or vertical axis in use. This typically allows the rotary means or blades to rotate in a plane substantially parallel to the longitudinal axis of the apparatus housing.

Preferably the rotary means are mounted so as to allow pivotable movement about a secondary axis or an axis substantially parallel to the longitudinal axis of the rotary means. This pivotable movement allows teetering or twisting movement of the rotary means.

In one embodiment the rotary means are mounted so as to allow pivotable movement about a further or third axis or about an axis at an acute angle relative to a substantially vertical axis (i.e. movement through an acute angle relative to a vertical axis to provide a see-saw or tilt effect which is at substantially 90 degrees relative to the secondary axis of twist). This allows the plane of rotation of the rotary means to tilt independently of the housing, thereby increasing the speed by which the apparatus can respond to disturbances or external forces applied to the aircraft.

The rotary means can include any suitable number of rotary blades, such as two, three, four rotary blades and/or the like.

Each rotary blade is preferably relatively thin and broad. Preferably the lower surface is substantially concaved or curved in shape.

The rotary means are mounted on top of the housing and the rotary means are capable of rotation a spaced distance above a top of the housing.

In one embodiment the flying apparatus is in the form of a hovering craft, such as for example a helicopter. The housing can be in the form of a body or fuselage of the helicopter. The helicopter body has a tail with further or secondary rotary means associated with the tail. The tail rotary means typically rotate about an axis substantially perpendicular to the axis of rotation of the main rotary means with the weighted means associated therewith.

Preferably the flying apparatus is in the form of a toy, and further preferably is in the form of a toy helicopter. The appearance of the toy helicopter is typically more realistic than prior art toys since there is no requirement for a fly bar or secondary rotary means located directly above the primary or main rotary means.

In one embodiment of the toy helicopter design or flying apparatus, one or more vanes are provided which protrude outwardly from one or more sides of the housing to provide further stability to the apparatus. The side vanes are typically in a sheet like form. The side vanes can be oppositely located on the body of the helicopter or apparatus. Any number of vanes can be provided but typically the vanes are in such number so as to balance the housing.

The front or nose of the toy helicopter or flying apparatus can be slightly weighted, such as via weight means, compared to the tail or rear of the toy or apparatus so that it flies in a forwardly direction and is steered using the tail rotor or further rotor.

Control means used with the toy or apparatus preferably allow independent control of the tail rotor and the main rotor.

Preferably the flying apparatus has second or further rotary means associated with the housing. The second or further rotary means preferably rotate about an axis substantially perpendicular to the axis of rotation of the main rotary means.

In one embodiment the flying apparatus is in the form a spinning craft. The spinning craft typically does not have secondary rotary means. As such, the craft spins around a substantially vertical axis in use. For example, the apparatus can be in the form of a spinning toy flying saucer which can be made air-borne in use and/or the like.

The toy apparatus of the present invention is typically of a small size and is suitable for use indoors.

Preferably the toy or flying apparatus is remote controlled. Control means in the form of a remote control handset can be provided via which the user controls the operation, movement and/or direction of the flying apparatus or toy. The control means can communicate with the flying apparatus via wired means or wireless means, such as infra red, radio frequency and/or the like. Transmitter and/or receiver means can be provided on the control means and corresponding transmitter and/or receiver means can be provided on the flying apparatus to allow communication between said control means and said flying apparatus.

Preferably drive means are provided and are associated with the first and/or second rotary means to drive rotation of the same. In a preferred embodiment the drive means are provided in the housing of the apparatus. The drive means can include a motor and/or suitable gearing for driving rotation of the rotary means.

Power means can be provided to power the drive means. The power means can include mains power, battery power, rechargeable battery power and/or the like.

In one embodiment the weighted means are mounted at an acute angle to the leading edge(s) of the rotary means to provide a phase-lead which balances out the residual gyroscopic reaction force caused by the 90 degree reaction force.

According to a second aspect of the present invention there is provided a method of using flying apparatus, said apparatus including a housing and rotary means associated with said housing, said method including the steps of driving rotation of the rotary means in use, said rotary means including two or more rotary blades and wherein each of said rotary blades has weighted means associated with at least a part of a leading edge thereof.

According to a further aspect of the present invention there is provided rotary means for use with flying apparatus, said rotary means including two or more rotary blades arranged to rotate about a first axis in use, and wherein weighted means are associated with at least a part of a leading edge of each of said rotary blades.

Preferably the rotary blades are arranged to pivot about a second axis substantially parallel to the longitudinal axis of the rotary blades. This second axis is preferably substantially perpendicular to the first axis.

Yet further preferably the rotary blades are arranged to pivot about a third axis which is substantially at 90 degrees to both the first and second axes.

### DETAILED DESCRIPTION OF THE DRAWINGS

Detailed embodiments of the present invention will now be described with reference to the accompanying figures, wherein:

FIG. 1 is a detailed view of the rotary arrangement of a prior art helicopter;

FIG. 2 is a detailed view of the rotary arrangement of a toy helicopter according to an embodiment of the present invention;

FIG. 3 is a simplified view of a rotary arrangement on a toy helicopter according to an embodiment of the present invention;

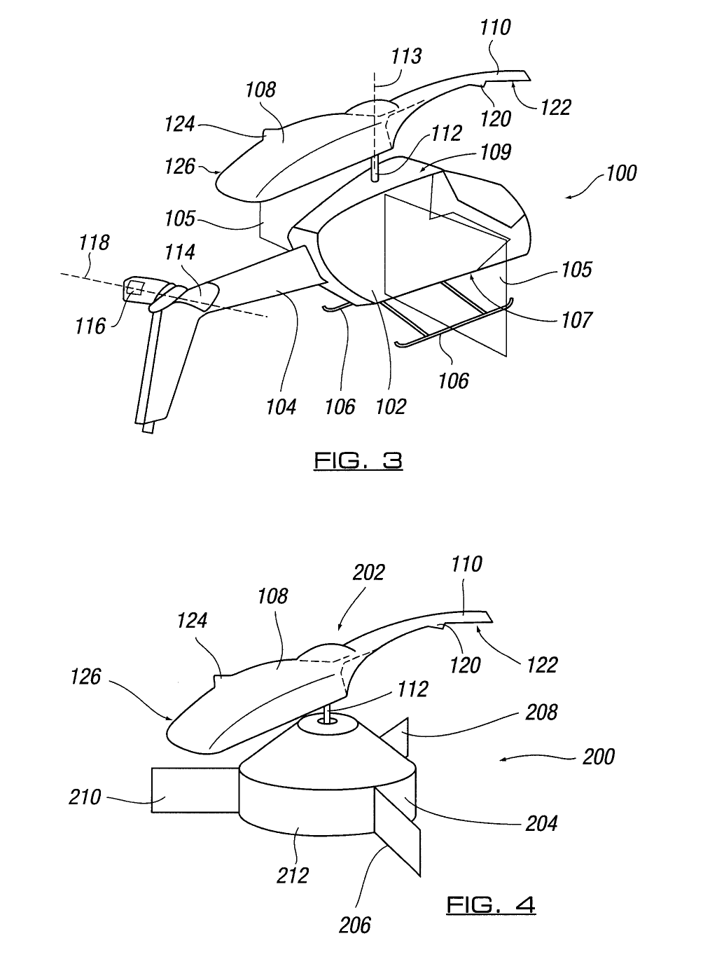

FIG. 4 is a simplified view of a rotary arrangement on a toy spinning craft according to a further embodiment of the present invention.

### DETAILED DESCRIPTION OF THE DRAWINGS

Referring firstly to FIG. 3, there is illustrated a remote control operated toy helicopter 100 according to an embodiment of the present invention. Helicopter 100 includes a housing in the form of a helicopter fuselage 102 and a tail 104 extending to a rear of the fuselage. A pair of landing feet 106 attached to a base 107 of fuselage 102 extends downwardly therefrom. Sheet like side vanes 105 protrude outwardly from opposite side walls of the fuselage 102 to provide increased stability by preventing oscillation of the toy body. First rotary means in the form of two rotary blades 108, 110 are joined to a top 109 of helicopter 110 via a rotatable shaft 112 and are rotatable about said shaft 112 in use (i.e. rotatable about a substantially vertical axis or axis 113 in use). Second rotary means in the form of two rotary blades 114, 116 are rotatable about an axis substantially perpendicular to the axis of rotation of said first rotary blades 108, 110 (i.e. rotatable about a substantially horizontal axis or axis 118 in use). The secondary rotary blades are used to steer the helicopter.

The remote control hand set used by the operator, such as a child or adult, is not shown but any suitable remote control hand set can be used as required. In one example, the fuselage 102 includes an infra red receiver which receives signals from an infra red transmitter provided on the remote control hand set, thereby communicating control signals from the handset to the helicopter.

Drive means, such as a motor and suitable gearing can be provided in the fuselage 102 to allow driving of the rotation of shaft 112. Rotation of shaft 112 results in rotation of rotary blades 108, 110. Power means in the form of a battery can be located in fuselage to power the drive means in use. A separate motor can be used to drive rotation of the tail rotary blades 114, 116, thereby allowing the main rotary blades to be controlled separately and independently to the tail rotary blades.

In accordance with the present invention, weighted means in the form of a first weight portion 120 protrudes in the direction of rotation of leading edge 122 of first rotary blade 110, and a second weight portion 124 protrudes in the direction of rotation of leading edge 126 of second rotary blade 108, as shown in FIGS. 2 and 3. The weight portions 120, 124 in the illustrated example are typically of substantially equal weight and are provided a substantially equal spaced distance apart along the leading edge of the blades from the central rotation point of shaft 112. However, the weight portions could be different weights and/or any suitable separation of the weight portions 120, 124 could be used providing the blades with the weight portions are substantially balanced in use.

In addition, rotary blades 108, 110 are capable of a limited degree of pivotal movement about an axis 128 which is substantially parallel to the longitudinal axis of blades 108, 110, as shown by arrow 130 in FIG. 2. Thus, weight portions 120, 124 act in place of a conventional “flybar” that is used in the prior art, as shown by the dotted line 132 in FIG. 2. By integrating or associating the weights directly with the main rotary blades 108, 110, this simplifies the design of the rotary arrangement and reduces the materials required to make the same. This produces a less expensive and easier to assembly final product.

Referring to FIG. 4, there is illustrated a further embodiment of the present invention wherein the remote controlled flying apparatus is in the form of a spinning craft 200 without a tail rotor. The craft 200 is able to spin and hover in an airborne position in use. A similar rotary arrangement 202 used in FIGS. 2 and 3 is used with the craft 200 and the same reference numerals are used to depict the same parts.

Spinning craft 200 has a housing 204 with three side vanes 206, 208, 210 protruding outwardly and radially therefrom. Side vanes 206, 208, 210 are in a sheet like form and the edges are arranged in a substantially vertical plane relative to the side walls 212 of the housing 204. The side vanes provide aerodynamic drag which slows the rotation of the housing 204.

It will be appreciated that the housing 204 can be any suitable size, shape and/or design providing the housing is adequately balanced by rotary blade arrangement 202.

The resulting craft 200 produced by using the rotary arrangement 202 is unconditionally stable and is able to self-rectify or automatically recover from almost any angle. Furthermore, since the craft is simple and lightweight, it has a high power to weight ratio and makes an exciting toy for a child or adult. The craft 200 spins about a substantially vertical axis or an axis substantially perpendicular to the side vanes.

The rotary arrangement of the present invention can be formed from any or any combination of suitable material or materials.

Thus, it can be seen that the present invention provides a form of damping for a hovering toy without introducing a 90 degree reaction force which would propel the toy into uncontrolled circular movement. When a helicopter for examples moves horizontally in a forwardly direction, the rotor blades will gain some airspeed while traversing through a semi-circle during which time they are moving forwards, and will lose some airspeed while traversing the semi-circle during which time they are moving backwards. This lift imbalance tries to tip the helicopter side ways and the resulting gyroscopic reaction actually tilts the helicopter backwards causing it to decelerate. This effect reduces as the helicopter slows down but it only fully goes away when the helicopter is stationary, thus there is a natural tendency for the helicopter to stop and hover. On most helicopters this is undesirable, since it limits forward speed and impairs handling. It is therefore minimised by design and at slow speeds the effect is overwhelmed by other factors. However, when combined with a teetering rotor or a rotor capable of undergoing twist according to the present invention, it provides a mechanism for inherent stability. The resulting helicopter or flying apparatus is automatically self righting and can be hovered with just throttle control to control rotor speed.

1. Flying apparatus, said apparatus including
a housing and rotary means associated with said housing capable of rotation in use,
said rotary means including two or more rotary blades and each of said rotary blades has weighted means associated with at least a part of a leading edge of said rotary blades, and
wherein the apparatus is in the form of a spinning craft.

2. Flying apparatus according to claim 1 wherein the weighted means protrude outwardly in front of a leading edge of each rotary blade.

3. Flying apparatus according to claim 1 wherein the weighted means are integrally formed with the rotary blades.

4. Flying apparatus according to claim 1 wherein the weighted means are attached or detachably attached to the rotary blades via attachment means.

5. Flying apparatus according to claim 4 wherein the attachment means include any or any combination of one or more screws, clips, ties, hook and loop fastening, inter-engaging members, adhesive, welding, or friction fit.

6. Flying apparatus according to claim 1 wherein the weighted means on each rotary blade is of substantially the same weight.

7. Flying apparatus according to claim 1 wherein the weighted means on each rotary blade is spaced substantially the same distance from the main axis of rotation of the rotary blades.

8. Flying apparatus according to claim 1 wherein the weighted means on each rotary blade protrudes from the leading edge of the blade by a substantially equal distance.

9. Flying apparatus according to claim 1 wherein the weighted means includes a single weighted portion positioned at a single location on the rotary blade.

10. Flying apparatus according to claim 1 wherein the weighted means includes two or more weighted portions positioned at two or more locations on the rotary blade.

11. Flying apparatus according to claim 1 wherein the rotary blades rotate about a primary or substantially vertical axis in use.

12. Flying apparatus according to claim 11 wherein the rotary blades are mounted so as to allow pivotable movement about a secondary axis or an axis substantially parallel to the longitudinal axis of the rotary blades.

13. Flying apparatus according to claim 11 or 12 wherein the rotary blades are mounted so as to allow pivotable movement about a further or third axis or an axis arranged at an acute angle to the vertical.

14. Flying apparatus according to claim 1 wherein a lower surface of each rotary blade is substantially curved or concave in shape.

15. Flying apparatus according to claim 1 wherein one or more vanes are provided to protrude outwardly from one or more side walls of the housing.

16-17. (canceled)

18. Flying apparatus according to claim 1 wherein drive means are provided to drive rotation of the rotary means.

19. Flying apparatus according to claim 18 wherein the drive means includes one or more motors.

20. (canceled)

21. Flying apparatus according to claim 1 wherein the apparatus is remote controlled using control means.

22. Flying apparatus according to claim 1 wherein power means are provided to power drive means which drive rotation of the rotary means.

23. Flying apparatus according to claim 1 wherein the weighted means are provided at an acute angle to the leading edge of the rotary blade.

24-25. (canceled)

26. A method of using flying apparatus, said apparatus including
a housing and rotary means associated with said housing,
said method including the steps of driving rotation of the rotary means in use, said rotary means including two or more rotary blades and each of said rotary blades has weighted means associated with at least a part of a leading edge thereof, and
wherein the apparatus is in the form of a spinning craft.

27. (canceled)
